(19) United States
(12) Patent Application Publication
(10) Pub. No.: US 2004/0091723 A1
(43) Pub. Date: May 13, 2004

(54) Multilayered shaped bodies with locally defined reinforcing elements

(76) Inventors: Thomas Engels, Frechen (DE); Bernd Mayer, Dusseldorf (DE); Werner Opitz, Langenfeld (DE)

Correspondence Address: Daniel J Harbison, Connolly Bove Lodge & Hutz, PO Box 2207, Wilmington, DE, 19899-2207, US

(21) Appl. No.: 10/433,600

(22) PCT Filed: Nov. 28, 2001
(86) PCT No.: PCT/EP01/13893

(30) Foreign Application Priority Data
Dec. 7, 2000 (DE) 100 60 816.7

(51) Int. Cl. B32B 15/04

(52) U.S. Cl. 428/461; 428/457

(57) ABSTRACT

Multilayered shaped bodies with locally demarcated reinforcing elements are described. The multilayered shaped body here is constructed of two outer metallic layers and at least one intermediate layer, this intermediate layer comprising an organic binder and reinforcing elements embedded in anisotropic distribution arranged therein. These anisotropic reinforcing elements are arranged at the points of the intermediate layer of the component which are particularly exposed to high structural stresses or actions of force, or at which a high acoustic radiation occurs. These multilayered shaped bodies allow provision of laminated bodies which have a low specific gravity and a high structural strength, and are preferably employed in machine construction, vehicle construction or apparatus construction.

The present invention relates to multilayered shaped bodies of two outer metallic layers and at least one intermediate layer, a process for the production thereof and the use of these shaped bodies. Multilayered shaped bodies and processes for the production of multilayered shaped bodies are widely used in all instances where it is a matter of employing structures of low specific gravity with a high level of strength and/or rigidity.

Materials of low specific gravity are increasingly being employed in machine, vehicle or apparatus construction, in particular in automobile construction, in order to reduce the weight of the components or vehicles. For the most diverse reasons (legislation, fuel consumption, fuel prices), a requirement which is becoming ever more important in the construction and building of motor vehicles is the increase in the structural strength of an automobile construction or of a specific component, with a simultaneous reduction in the weight. However, for reasons of structural strength of the particular construction, the sheet thicknesses of conventional metal constructions can now be further reduced to save weight only if a change is made to lighter (e.g. aluminum) or structurally stronger metals (e.g. multiphase steels) as the construction material. Lightweight construction with ever thinner sheet thicknesses arrives at boundaries above all where, for geometric reasons, due to reduced cross-sections of the components the rigidity thereof no longer meets the requirements of being fit for the use. For production reasons and price reasons, the path via lighter or structurally stronger metals is followed to only a small extent, since the forming properties are less favourable compared with normal steel sheets, and furthermore higher tool costs may arise. For safety reasons also, these materials have hitherto been employed to only a small extent, since these materials have less favourable properties in respect of energy absorption and material failure in the event of a crash than the conventional materials. Plastics indeed have a low specific gravity, but as yet do not reach the performance level of metallic materials by far, and are therefore at present not yet employed in the field of structurally strong and load-bearing components.

Since the ideal construction principle or material for an optimum in respect of the performance/weight ratio has not yet been found, the following types of procedure are currently found in vehicle constructions: conventional construction with the aid of steel sheets as the material, aluminum constructions, mixed constructions, i.e. combinations of the most diverse metals, inter alia also with plastics, and sandwich structures. In the case of the structures mentioned last, the general build-up principle is a composite of two covering layers of metal with an organic intermediate layer of plastic. Further intermediate layers in the form of fiber inlays or sheet-like structures e.g. of glass fibers or expanded metal sheets, can additionally be incorporated.

EP-A-13146 discloses a metal/thermoplastic/metal laminate which has a weight per unit area of less than 9.76 kg/m² and comprises a thermoplastic core material based no partly crystalline polyamides or polyesters with a crystalline melting point >130° C. and a metal layer which is laminated on to both sides of the core material, the metal layer having a melting point above the crystalline melting point of the thermoplastic core layer and the metal layer having a minimum thickness of 0.0127 mm. The construction industry, apparatus industry, automobile industry and aircraft construction are stated as the use for these sandwich materials.

U.S. Pat. No. 4,759,994 describes a sandwich-like structure comprising two outer metal plates and an inner core between the two outer plates. The core comprises a metallic network or grid. This sandwich structure has a layer of adhesive between the metal plates, which joins the two plates and the core to one another, as a result of which the punching properties are improved. The adhesive here should be only within the grid-work of the core material, while the contact zones between the core and metal plates should remain free of adhesive in order to allow weldability of the composite materials.

DE 19729566 C2 describes a composite metal plate with two outer sheets which are kept at a distance by elevations on a structural slab of lightweight construction arranged in between, the structural slab of lightweight construction and the outer sheets being joined to one another at the elevations by soldering, welding or gluing. An expanded metal is proposed here as the structural slab of lightweight construction.

EP-A-895852 describes a multilayered steel sandwich structure comprising two metal plates laminated on to a core. This core is constructed of high-grade steel wool. The sandwich structure is effected here by soldering, welding or gluing. Phenolic resins, epoxy resins or polyethylene/maleic anhydride or polypropylene/maleic anhydride copolymers are proposed as adhesives.

DE-A-3905871 discloses a composite material for thermal insulation and/or soundproofing which has a structurally strong shell layer of a heat-stable metal foil on at least one side. A heat-stable, highly porous inorganic material is proposed as the insulating layer, for example foamed glass with a sponge-like structure or gas concrete or foamed ceramic or clay mineral materials. Exhaust areas of an automobile are proposed as a use for this composite material in the automobile sector.

DE-A-3935120 discloses a process for the production of multilayered composite sheets in which this composite sheet comprises a cover plate and base plate and has in between a spacer material of wire or a metal grid as a spacer material, this being shaped to flatten its grid nodules before being joined with the outer metal slabs. Enlarged joining surfaces between the metal grid and the metal slabs are provided as a result, which are also said to allow forming. The specification indeed states that the metal grid can in principle be joined with the cover sheets by adhesive processes, but welding processes are said to be preferred. Further details of suitable adhesives are not to be found in this specification.

WO 00/13890 describes glued multilayered composite sheets and processes for the production of multilayered composite sheets which comprise two outer metal plates which serve as upper and lower base plates and which are bonded to a deformable joining intermediate layer. The deformable spacer material lying in the intermediate layer is joined here to the cover and base plate by means of a foaming adhesive which fills the hollow spaces remaining in the composite. The spacer material lying between the metal plates can comprise here an expanded metal grid, a wire grid or a spacer sheet, and it can include a multilayered sequence of expanded metal grids, wire grids and spacer sheets with intermediate sheets which are impermeable or permeable to the adhesive. No disclosure regarding suitable compositions of the adhesive is to be found in this specification.

EP 636517 B1 discloses a production process for a vehicle body component which has, at least in areas, a double-sheet structure with an insulating layer in between. In this process, the base sheet and the top sheet of the double-sheet structure are first fixed to one another, an insulating layer being inserted in between, and are then formed, in particular deep-drawn, together. A suitable insulating layer material is said to be merely laid on selected area sections of the flat base sheet, and a flat top sheet extending over a larger section of the area is laid on this, the insulating layer initially being sufficiently pressure-stable in the edge region to withstand the forming. The insulating layer material is said here to be glued to the base sheet and the top sheet, the adhesive required for the gluing being applied by film, sealing thread, rolling on/rolling, spray film, adhesive bead or drops.

The prior art furthermore discloses a method of reinforcing thin-walled metal structures at severely stressed points, in which so-called “metal patches” are glued on to the base sheet. Such structures are described e.g. in JP 2000/135,923 A, DE 19819697 A1, DE 4445943 C1, DE 4445942 C1 or DE 2932027 A. A disadvantage of this process is that at least one side of such sheet structures does not have a flat surface.

In view of this prior art, the inventors had the object of providing multilayered shaped bodies, and a process for their production, which are suitable for the structural areas of vehicle construction.

The object according to the invention can be seen from the claims, and substantially comprises providing multilayered shaped bodies of two outer metal layers and at least one intermediate layer, the overall area of the laminated body has an anisotropic structure.

The present invention also provides a process for the production of such multilayered shaped bodies and the use of multilayered laminates or shaped bodies for the production of components in automobile construction.

The two outer metallic layers of the multilayered shaped body here are as a rule metal sheets. These sheets here can be normal steel sheets or also steel sheets which have been treated by the various galvanizing processes, and there may be mentioned here the electrolytically or hot-dip galvanized sheets and the corresponding steel sheets which have been after-treated with heat or galvanized or subsequently phosphated as well as aluminum sheets. The thickness of these outer sheets can be adapted to suit the structural circumstances. They can be between 0.1 and 1.0 mm, preferably between 0.1 and 0.5 mm, preferentially between 0.2 and 0.3 mm. The intermediate layer here comprises a polymeric binder composition and the reinforcing elements distributed anisotropically therein. The binder of the intermediate layer here can be chosen from a large number of thermoplastic polymers or also from reactive binders. Examples of thermoplastic polymers are polyethylene, polypropylene, polyamide, polystyrene or styrene copolymers, such as e.g. acrylonitrile/butadiene/styrene (ABS) or thermoplastic elastomers based on block copolymers of styrene with butadiene or isoprene, optionally also in their hydrogenated form, both preferably as three-block copolymers. Further examples of thermoplastic polymers which are to be co-used according to the invention for the intermediate layer are vinyl chloride homo- and/or copolymers—e.g. vinyl chloride/vinyl acetate copolymers, ethylene/vinyl acetate copolymers (EVA), polyester or polycarbonate. Particularly suitable reactive binders are those based on epoxy resins, reactive rubbers or polyurethanes.

A large number of—preferably flexibilized—epoxide compositions are suitable as the epoxy resin binder composition. Examples which may be mentioned are the compositions mentioned in EP-A-354498, EP-A-591307, WO 00/20483, WO 00/37554 and the still unpublished Applications DE 10017783.2 and DE 10017784.0. The binder compositions to be used according to the invention comprise here at least one epoxy resin, a flexibilized epoxide compound, elastomer-modified epoxy resin and optionally a reactive thinner and as a rule a latent hardener, which effects crosslinking of the binder when the compositions are heated.

Compositions of naturally occurring and/or synthetic rubbers (i.e. elastomers containing an olefinic double bond) and vulcanization agents are suitable as the binder matrix based on reactive rubbers. These comprise at least one of the following substances: one or more liquid rubbers and/or solid rubbers or elastomers, finely divided powders of thermoplastic polymers, vulcanization agents, vulcanization accelerators, catalysts, fillers, tackifiers and/or adhesion promoters, blowing agents, extender oils, anti-ageing agents and rheology auxiliaries. Suitable binders are described e.g. in WO 96/23040.

In addition to the abovementioned binders which are thermosetting as one component, two-component epoxide, rubber or also polyurethane binders which cure at room temperature can also be employed.

The anisotropically distributed reinforcing elements of the intermediate layer here can be constructed from conventional metal sheets, hardened metal alloys, multiphase steels, aluminum, expanded metals, organic foams based on epoxides or polyurethanes, which are optionally fiber-reinforced, or other plastics. These reinforcing elements here are preferably arranged at those points at which the shaped body is exposed to high structural stresses or actions of force. These reinforcing elements are already incorporated in the production of the multilayered shaped body as a semi-finished product (“multilayer laminate”) such that these are then later present exactly at the points of the construction or component at which the particularly high structural stresses or actions of force have an effect on the component. These reinforcing elements are preferably tailor-made here in their geometric shape specifically to the load case.

The multilayered shaped bodies according to the invention can furthermore additionally comprise functional built-in elements, such as e.g. cable channels. This procedure is particularly appropriate if these shaped bodies are to be used as roof constructions or under-body groups in vehicle construction.

The possible embodiments of the multilayered shaped bodies according to the invention are now to be explained in more detail with the aid of drawings. In these:

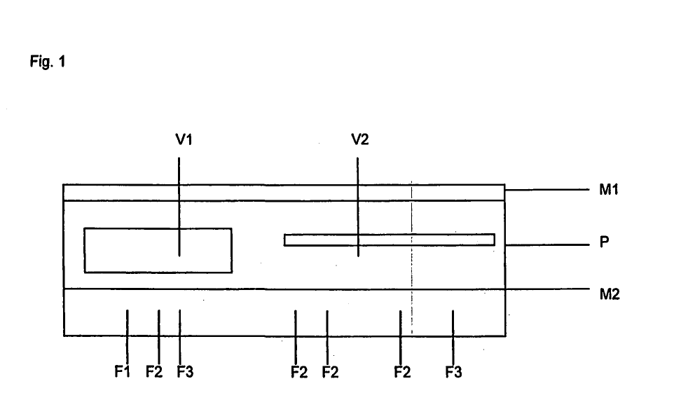

FIG. 1 shows the general construction of an anisotropic multilayered laminate

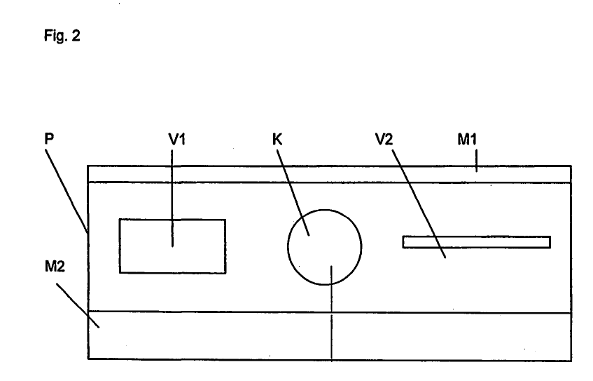

FIG. 2 shows the additional incorporation of functional elements

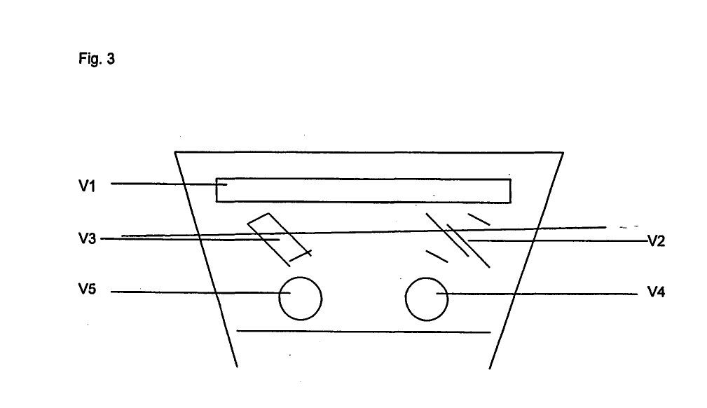

FIG. 3 shows an example of a construction of an engine bonnet

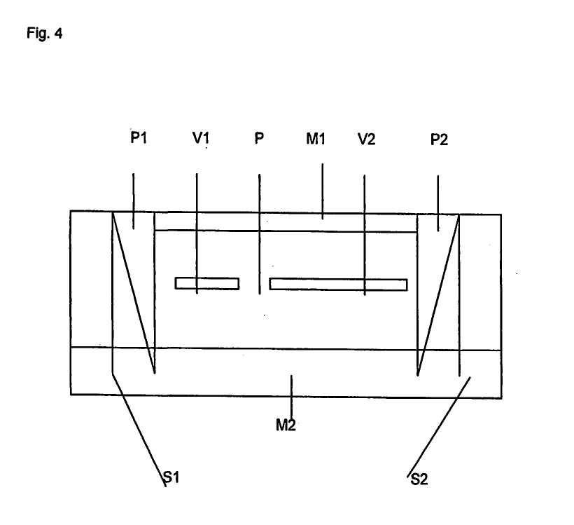

FIG. 4 shows an embodiment example for a weldable component.

In the general construction of the multilayered laminate according to FIG. 1, the two outer metal layers (M1) and (M2) are metal sheets with a thickness of 0.1 to 1.0 mm. The polymer layer (P) in between as a rule has a layer thickness of 0.3 to 5.0 mm, and its thickness depends on the intended use of the component produced from the multilayered laminate. Polymers which can be employed are all the abovementioned types of polymers. The thicker reinforcing element (V1) is arranged at a point where the greatest action of force (F1) is later to be expected in the component. The reinforcing element (V2) is at a point where a lower force (F2) will act. At points with even less action of force (F3), no reinforcing element is provided.

FIG. 2 additionally shows the incorporation of a functional element, for example a channel (K) for accommodating electrical cables. The other structural components of this laminated body correspond to the elements shown in FIG. 1.

FIG. 3 shows an example of the construction, in diagram form, of an engine bonnet in plan view. The geometric dimensions of the reinforcing elements (V1) to (V5) here are adapted to suit the requirements of the actions of force on the engine bonnet and the vibration properties of the bonnet itself. This is important for mechanical rigidity and/or minimization of the acoustic radiation of the bonnet. For completeness, it should be mentioned that the reinforcing elements are not visible from the outside.

FIG. 4 shows an embodiment example of a multilayered shaped body which is to be employed as a weldable component. Here also, the anisotropically distributed reinforcing elements (V1) and (V2) in turn are arranged in the polymeric binder matrix (P), but the metal sheet (M1) does not extend to the edge region. The edge regions of the lower metal layer (M2) are provided with welding points (S1) and (S2) such that this component can be installed with conventional welding processes, in particular electrical welding processes. These welding points here are preferably separated from the metal sheet (M1) by regions of the polymeric binder matrix (P1) and (P2). Multilayered shaped bodies according to FIG. 4 can of course also be joined into the vehicle body with the aid of structural adhesives, instead of being welded.

The multilayered shaped bodies according to the invention here can in principle be produced by continuous or discontinuous production. In the case of continuous production, a lower cover sheet runs horizontally into the production plant and a first binder layer of the abovementioned polymeric binders is then applied with the aid of a slit dye or with a roller from the top on to the lower cover sheet running past.

The reinforcing elements and/or functional built-in elements are then placed on the binder layer at the predetermined points, preferably with the aid of a robot. A second binder layer is then also applied with the aid of a slit dye or a roller from the top on to the semi-finished product running past underneath, this comprising the lower cover sheet, binder layer and reinforcing elements. An upper cover sheet is joined to the semi-finished product formed in this way, to give a complete laminated body, and the entire laminated body is pressed to the final layer thickness with the aid of rolls, optionally while heating. In the case of reactive binder systems, heating during the joining and/or pressing can be such that crosslinking of the binder system is carried out to an intermediate stage, e.g. to a precuring, so that the binder—and therefore the multilayered laminate—can still be shaped to a very high degree and the multilayered laminate produced in this way can easily be shaped in conventional forming processes. Final curing can then take place in the oven for electro-dipcoating after installation of the component produced in this way, e.g. in a motor vehicle body.

In the discontinuous production procedure, a preform is punched out of a lower cover sheet, a first binder layer of the abovementioned polymeric binders is applied to the punched lower cover sheet with the aid of a slit dye or a roller or a doctor blade, and the reinforcing elements and/or functional built-in elements are placed on the binder layer at the predetermined points, optionally with the aid of a robot. Application of a second binder layer with the aid of the abovementioned application methods follows, the upper cover sheet is joined to the laminated body preformed in this way and the entire laminated body is pressed to the final layer thickness with the aid of rolls or presses, optionally with heating. The laminate produced in this way can then be pressed or deep-drawn by forming into a three-dimensional shaped body.

In this discontinuous production procedure also, in the case of reactive binders curing thereof can take place in two stages, so that the forming is facilitated, and the final hardness is achieved only after incorporation of the preform into the complete subassembly.

The multilayered shaped bodies produced according to the invention can be employed for a large number of uses in which materials which have a low specific gravity and a high structural strength are required. Examples which may be mentioned are the abovementioned fields of use in machine construction, in apparatus construction and in vehicle construction, and here in particular in automobile construction. Concrete examples from automobile construction are the production of roof constructions, engine bonnets, door side components, boundary walls to the engine space (“fire wall”), under-body subassemblies and the boundary wall to the boot.

Compared with the components employed to date, the multilayered preforms according to the invention have the following advantages:

low specific gravity,

low overall weight,

the structural reinforcing performance can be significantly improved locally at points subjected to high stress in large-area regions of a vehicle body,

due to the laminate construction—e.g. for roof constructions, engine bonnets or door side components, improved acoustic properties can be achieved, and furthermore the construction depth of such components can be reduced and additional useful space can thus be obtained,

by choice of suitable polymeric binders, an improved thermal and heat resistance of up to 300° C. can be achieved, which is important for use in the under-body region or as a boundary wall to the engine space (“fire wall”),

the incorporation of functional elements, such as e.g. cable channels, in the organic intermediate layer is possible, e.g. for use in the roof or under-body region,

by a staggered production procedure in which the components are produced separately from the production line (“preformed laminate”), individual high-performance modules or high-performance components can be constructed very rapidly and flexibly.

1. Multilayered shaped body of two outer metallic layers and at least one intermediate layer, characterized in that the overall area of the laminated body has an anisotropic structure.

2. Multilayered shaped body according to claim 1, characterized in that the intermediate layer comprises a polymeric binder composition and reinforcing elements distributed anisotropically therein.

3. Multilayered shaped body according to claim 2, characterized in that the anisotropically distributed reinforcing elements of the intermediate layer are arranged at those points at which the shaped body is exposed to high structural stresses or actions of force and/or the acoustic radiation of the shaped body or component is significantly reduced by such reinforcing elements.

4. Multilayered shaped body according to claims 1 to 2, characterized in that the anisotropically distributed reinforcing elements of the intermediate layer are constructed from conventional metal sheets, hardened metal alloys, multiphase steels, aluminum, expanded metals, plastics or organic, optionally fiber-reinforced foams based on epoxides or polyurethanes.

5. Multilayered shaped body according to claim 1 or 2, characterized in that the intermediate layer additionally comprises functional built-in elements, in particular cable channels.

6. Multilayered shaped body according to at least one of the preceding claims, characterized in that the binder of the intermediate layer is built up from thermoplastic polymers chosen from polyethylene, polypropylene, polyamide, polystyrene, styrene copolymers, vinyl chloride homo- and/or copolymers, EVA, polyesters, polycarbonate or reactive binders chosen from epoxy resins, reactive rubbers or polyurethanes.

7. Process for the production of a multilayered shaped body in the form of a multilayered laminate according to at least one of the preceding claims, characterized by the following essential process steps
a) a lower cover sheet runs horizontally into the production plant,
b) a first binder layer according to claim 6 is applied with the aid of a slit dye or a roller from the top on to the lower cover sheet running underneath,
c) the reinforcing elements according to claim 4 and/or the functional built-in elements are placed on the binder layer at the predetermined points, optionally with the aid of a robot,
d) a second binder layer according to claim 6 is applied with the aid of a slit dye or a roller from the top on to the lower cover sheet coated according to a) to c) running underneath,
e) an upper cover sheet is joined to the laminated body formed according to a) to d),
f) the entire laminated body is pressed to the final layer thickness with the aid of rolls, optionally with heating.

8. Process for the production of a multilayered shaped body according to at least one of claims 1 to 6, characterized by the following essential process steps:
a) a preform is punched out of a lower cover sheet,
b) a first binder layer according to claim 6 is applied with the aid of a slit dye or a roller from the top on to the lower cover sheet running underneath,
c) the reinforcing elements according to claim 4 and/or the functional built-in elements are placed on the binder layer at the predetermined points, optionally with the aid of a robot,
d) a second binder layer according to claim 6 is applied with the aid of a slit dye or a roller from the top on to the lower cover sheet coated according to a) to c) running underneath,
e) an upper cover sheet is joined to the laminated body formed according to a) to d),
f) the entire laminated body is pressed to the final layer thickness with the aid of rolls or presses, optionally with heating,
g) the laminate produced according to a) to f) is pressed or deep-drawn by forming into a three-dimensional shaped body.

9. Use of multilayered laminates or shaped bodies according to claim 7 or 8 for the production of components for automobile construction.

10. Use according to claim 9 for the production of roof constructions, engine bonnets, door side components, a boundary wall to the engine space (“firewall”) or under-body subassemblies.
